(19) United States
(12) Patent Application Publication
(10) Pub. No.: US 2026/0346751 A1
(43) Pub. Date: Nov. 5, 2026

(54) Charging an Electric Vehicle at a Charging Point of a Property

(71) Applicant: Bayerische Motoren Werke Aktiengesellschaft, Muenchen (DE)

(72) Inventors: Jens BERGER, Muenchen (DE); Martin LINGENHEIL, Freising (DE)

(21) Appl. No.: 19/120,275

(22) PCT Filed: Sep. 1, 2023
(86) PCT No.: PCT/EP2023/073985

§ 371 Date: Apr. 11, 2025

(30) Foreign Application Priority Data
Oct. 12, 2022 (DE) 10 2022 126 609.5

(51) Int. Cl. B60L 53/64; B60L 53/62; B60L 53/66; B60L 53/68; G06Q 50/06

(52) U.S. Cl. CPC B60L 53/64; B60L 53/62; B60L 53/66; B60L 53/68; G06Q 50/06; B60L 2240/70; B60L 2240/80; B60L 2270/10

(57) ABSTRACT

A method for charging an electric vehicle at a charging point of a property, whose local home energy network is connected to a public energy distribution network is provided. An incentive table creation unit of the property provides a set of incentive tables including an incentive table for the electric vehicle based on power consumption information of the property and power provision information of the energy distribution network, the incentive table creation unit transfers the set of incentive tables to an external IT system, the external IT system analyzes the set of incentive tables based on another item of information relevant for charging the electric vehicle, and, depending on the result of the analysis, the external IT system approves the set of incentive tables sent by the incentive table creation unit without any changes or creates a modified set of incentive tables including at least one altered incentive table.

### BACKGROUND AND SUMMARY

The invention relates to a method for charging an electric vehicle at a charging point of a property, the local household energy network of which is connected to a public energy distribution network, in which, when the electric vehicle is connected to the charging point, an incentive table creation device of the property creates a set of incentive tables comprising at least one incentive table for the electric vehicle on the basis of at least electricity provision information relating to at least one energy distribution network. The invention also relates to a charging infrastructure for charging an electric vehicle, which is configured to carry out the method. The invention furthermore relates to a system having such a charging infrastructure and at least one electric vehicle connected thereto via a respective charging point. The invention can be advantageously applied to single-family houses, in particular with a wallbox or a plurality of wallboxes as charging point(s) and in particular with a photovoltaic system.

DE 10 2009 036 816 A1 discloses a method and an apparatus for controlling charging stations for electric vehicles. To minimize peak power requirements, at least two charging stations are combined to form a group, actual charging parameters are exchanged within the charging stations within the group, a load forecast for the group is created on the basis of at least the actual charging parameters and target charging parameters are determined for the charging stations in the group depending on the load forecast.

DE 10 2013 010 774 A1 discloses a method for operating a charging station for electric vehicles, in which a maximum rated value for a charging current or a charging power is determined, the determined maximum rated value for the charging current or the charging power is transmitted to an electric vehicle electrically coupled to the charging station, a first interval of time is determined on the basis of at least the maximum rated value and the electric vehicle is charged with the maximum rated value of the charging current during the first interval of time. In order to increase the service life of the charging station, a reduced rated value for the charging current and a second interval of time are determined, wherein the second interval of time determines a period during which the charging current or the charging power must not exceed the reduced rated value, the reduced rated value is transmitted to the electric vehicle and the electric vehicle is charged with at most the reduced rated value of the charging current or the charging power during the second interval of time.

DE 10 2018 202 755 A1 discloses a method for adapting an electrical power offering to an electrical power requirement in an electrical network, from which at least one electrical charging station is operated, wherein, in the method, a control apparatus of the network creates, for at least one motor vehicle, a charging forecast that indicates the future charging period in which the motor vehicle will likely exchange electrical energy with the network, a temporal progression of the power requirement in the network is estimated on the basis of the respective charging forecast, a temporal progression of the power offering in the network is determined, and at least one predetermined compensation measure is initiated for at least one charging period for which it is recognized that the power offering is less than the estimated power requirement, wherein the power offering is adjusted to the power requirement by means of the at least one compensation measure.

US 2017/0136894 A1 discloses methods, apparatuses and systems for communication exchange between a vehicle and a charging system. The communication exchange may comprise charging request messages which are sent or received by the vehicle and define charging details, for instance a type of charging, charging locations, a charging orientation and/or other information corresponding to the charging requests for the requesting vehicle. The charging system can respond to the charging request messages by accepting or rejecting the vehicle charging request. In response to the acceptance of the request message, the charging system provides a charge for the vehicle according to the charging details.

US 2017/0140603 A1 discloses a system for managing vehicle fleets, comprising: a base management system that is configured to enable one or more fleet vehicles to receive a vehicle service, wherein the base management system comprises a database, a communication module and an analysis module, wherein the communication module communicates with the one or more fleet vehicles, the analysis module and the database; one or more fleet vehicles, wherein each fleet vehicle comprises a vehicle database and is respectively configured to receive a charging service and to communicate a vehicle state of charge to the communication module, at least one fleet service location that is configured to transmit a settlement price to the communication module and to provide the settlement service at the settlement price; wherein the analysis module receives the charging price and determines whether the at least one fleet service location has been selected to provide the charging service for at least one fleet vehicle operated in a deficient state of charge; wherein the at least one fleet vehicle operated in a deficient state of charge is provided with a charging service by the at least one fleet service location when the analysis module selects the at least one fleet service location.

An object of the present invention is to at least partially overcome the disadvantages of the prior art and to provide an improved option for the bidirectional charging of an electric vehicle at a charging point connected to a household energy network of a property.

This object is achieved according to the features of the independent claims. Preferred embodiments can be gathered from the dependent claims.

The object is achieved by means of a method for charging an electric vehicle at a charging point of a property, the local household energy network of which is connected to an energy distribution network, in which
when the electric vehicle is connected to the charging point, an incentive table creation device of the property provides a set of incentive tables comprising at least one incentive table for the electric vehicle based on electricity usage information relating to the property and electricity provision information relating to the energy distribution network,
the incentive table creation device transmits the set of incentive tables to the external IT system,
the external IT system analyzes the set of incentive tables based on at least one further item of charging-relevant information, and
depending on a result of the analysis, the external IT system approves the set of incentive tables sent by the incentive table creation device without change or creates a modified set of incentive tables comprising at least one changed incentive table,
the set of incentive tables that has been approved without change or, if present, the modified set of incentives tables is transmitted to the electric vehicle,
the electric vehicle converts a received set of incentive tables into a charging plan, and
the electric vehicle is charged according to the charging plan.

This method has the advantage that a set of incentive tables for an electric vehicle, which was created by the property-based incentive table creation device, can be analyzed by the “external IT system” entity in order to determine whether it can or should be replaced with a better set of incentive tables which has been created by the external IT system and, during the creation of which, the external IT system has further charging-relevant information that is not known to the property-based incentive table creation device.

The electric vehicle typically has a drive battery for driving the electric vehicle. The electric vehicle may be, for example, a hybrid vehicle, PHEV, or a fully electrically driven vehicle, BEV. The electric vehicle can be charged via a charging cable and/or inductively. The charging point may be a charging station, for example a wallbox, or a charging area that provides inductive charging. The fact that the electric vehicle is connected to a charging point may therefore comprise the fact that the electric vehicle is connected to a charging point via a charging cable or inductively. It is a development that the charging point and the electric vehicle are configured to charge and discharge the drive battery of the electric vehicle, which can also be referred to as “bidirectional charging”.

The local electrical energy network of the property (“household energy network”) is generally connected to the public energy distribution network via an electricity meter at or as the network connection point. It is a development that the electricity meter is an intelligent electricity meter (so-called “smart meter”) that can also be used, in one variant, to transmit data, for example relating to an electricity consumption or power flow, to the property, for example to the incentive table creation device, an HEMS (if present), etc. If the electricity meter is accessed solely by the operator of the energy distribution network or the measurement point operator, at least one local (private) energy measuring device/electricity meter may be additionally present for the purpose of informing the property about a current power flow, in particular a measuring device topologically connected in series with the conventional electricity meter.

It is a development that the property is a private house, such as a single-family house.

Electrical end consumers, such as kitchen appliances, laundry care appliances, lamps, media devices, boilers, air-conditioning devices, etc., are typically connected to the household energy network.

It is a development that at least one electricity generation device for generating electrical energy, such as a photovoltaic system, a wind turbine, a heat pump and/or a geothermal system, etc., is connected to the household energy network.

It is a development that at least one steady-state electrical energy store for buffering electrical energy is connected to the household energy network.

The incentive table creation device is used to forecast at least one possible aspect of a charging process of the electric vehicle in the form of at least one associated time-dependent forecast table (“incentive table”). By using the at least one incentive table, the electric vehicle can create a charging plan (a planned progression of a charging or discharge current between the charging point and the electric vehicle for a connection period of the electric vehicle) that is improved or optimized for the operator of the property and/or the operator of the electric vehicle. An incentive table may comprise, for example, forecast technical, economic and/or ecological information.

The fact that the incentive table creation device is a device of the property comprises the fact that the set of incentive tables or the incentive table(s) is/are based on properties of the property under consideration, for example its consumption, possibly energy generation, etc. The incentive table creation device may be a component of the property, in particular of the home network, or may be an external entity such as a cloud computer or a network server that is communicatively coupled to the property, in particular to the home network.

The electricity usage information relating to the property comprises a temporal forecast of an energy consumption of the household energy network, in particular of end consumers (“consumption information”) connected thereto. The forecast energy consumption of the household energy network may be derived from historical data, for example.

If the property also has at least one energy generation device, such as a photovoltaic system, a wind turbine, etc., the electricity usage information relating to the property can also comprise a temporal forecast of energy generation by the energy generation device, for example by using energy generation forecasts, for example derived from system parameters and weather forecasts (“energy generation information”). The temporal forecasts of the local energy consumption and of the local energy generation can be considered separately (for example by means of respective incentive tables) or additively (for example in a single incentive table).

The electricity provision information relating to the energy distribution network or the energy supplier contractually associated with the property may comprise, in particular,
a temporal forecast of procurement costs of electricity from the energy distribution network into the household energy network,
a temporal forecast of feed-in renumerations from the household energy network into the energy distribution network, and/or
a temporal forecast of CO2 emissions or availability of electrical energy generated from renewable energies. The temporal forecast of the procurement costs and of the feed-in renumeration can also be referred to together as tariff information. The forecast period may comprise, for example, 24 h, 48 h, a week, a month etc.

The fact that the set of incentive tables is provided may comprise, in one development, the fact that the set of incentive tables is created when the electric vehicle is connected to the charging point. In another development, the set of incentive tables can be provided by creating the set of incentive tables independently of the connection of the electric vehicle and being provided when the electric vehicle is connected.

In order to charge the electric vehicle, the external IT system has (charging-)relevant information which the incentive table creation device does not have or which cannot be accessed by the incentive table creation device. In this sense, the external IT system is “associated” with the electric vehicle. The external IT system analyzes the set of incentive tables transmitted by the incentive table creation device, taking into account the further charging-relevant information. The external IT system may be, in particular, an IT system maintained by a manufacturer of the electric vehicle. The external IT system can offer the analysis etc. to the property and/or the electric vehicle or perform it as a service and can accordingly be associated as a service provider.

The fact that the external IT system approves the set of incentive tables sent by the incentive table creation device without change depending on a result of the analysis is particularly relevant when a set of incentive tables created by the external IT system is not better or is not substantially better than the set of incentive tables created by the incentive table creation device. In this case, the external IT system can either provide no feedback or can transmit an explicit approval message to the incentive table creation device, for example.

If the external IT system has determined that a modified set of incentive tables created by it is more suitable than the set of incentive tables created by the incentive table creation device, the modified set of incentive tables is transmitted to the incentive table creation device.

The fact that the set of incentive tables approved without change is transmitted to the electric vehicle may comprise the fact that this set of incentive tables, after approval (for example by means of an explicit approval message or a lack of feedback) by the external IT system, is transmitted from the incentive table creation device to the electric vehicle.

The fact that the modified set of incentive tables is transmitted to the electric vehicle may comprise the fact that this set of incentive tables is transmitted from the external IT system to the incentive table creation device and from the incentive table creation device on to the electric vehicle.

The charging plan may provide for charging and discharging of the drive battery, if necessary. The charging plan comprises a temporal application of a charging power (that is to say a charging and/or discharging power) between the electric vehicle and the charging point, which can also be referred to as a “charging process”.

In addition to the set of incentive tables, the charging plan may also take into account vehicle-specific charging parameters of the electric vehicle which may be relevant to a charging process of the electric vehicle. Such charging parameters may comprise, for example, information relating to a desired or probable departure time, a state of charge desired at the departure time (“target SoC”) and/or a corresponding amount of energy, a state of charge that should not be undershot (“minimum SoC”) and a maximum and/or minimum charging and/or discharging power.

It is a configuration that the incentive table creation device is integrated in a household energy management system, “HEMS”. The HEMS is used to forecast an energy requirement for the household energy network and to optimize it such that at least one predefined target is met particularly well, for example low procurement costs from the public energy distribution network, environmentally friendly energy generation, etc. The optimization can already be carried out when an electric vehicle is connected to the household energy network as a buffer for a relatively long period. This is because the drive battery can be charged, for example, at times at which electrical energy can be procured from the public energy distribution network on particularly favorable terms, and the drive battery can be discharged, for example in order to reduce energy procurement for the household energy network from the public energy distribution network at times of high electricity prices and/or to feed excess energy from the household energy network into the public energy distribution network at times at which the associated renumeration is high. This optimization or the management of the electrical devices connected to the household energy network can be advantageously carried out in a particularly effective manner when at least one electricity generation device and at least one steady-state electrical buffer are available. Possible forecast data used for optimization by the HEMS may comprise, for example, the electricity usage information relating to the property and the electricity provision information relating to the energy distribution network.

In particular, during the period in which the electric vehicle is connected to the charging point, the drive battery of the electric vehicle can be used as an electrical buffer for the household energy network of the property controlled by the HEMS, for example in the sense of the so-called V2H (“Vehicle-to-Home”) and/or the so-called V2G (“Vehicle-to-Grid”) concept.

It is a configuration that the incentive table creation device is integrated in the charging point. This is particularly advantageous when the home energy network does not have an HEMS.

It is also possible for an HEMS with an incentive table creation device to be integrated in the charging point or for the charging point to have the function of the HEMS and the incentive table creation device.

It is a configuration that the set of incentive tables has
a charging power incentive table comprising a temporal progression of a maximum charging power,
at least one price incentive table comprising a temporal progression of a price for charging the electric vehicle, and/or
at least one emission incentive table comprising a temporal progression of a CO2 emission for charging the electric vehicle.

It is a development that the charging power incentive table, which can also be referred to as a “maximum power table”, comprises a temporal forecast of the maximum electrical power Pₘₐₓ(t) that can be used by the electric vehicle for charging, which forecast applies to the period when the electric vehicle is connected to the charging point. This maximum power is provided by the charging point, in particular the wallbox.

It is a development that the at least one price incentive table is calculated from the forecast electricity usage information relating to the property and the tariff information relating to the energy distribution network. It is a development that the at least one price incentive table comprises the forecast tariff information relating to the property or the household energy network and the tariff information relating to the energy distribution network for the connection period. It is a development that the at least one price incentive table comprises the tariff information relating to the energy distribution network, the forecast energy consumption for the connection period and the forecast energy generation by the energy generation device of the household energy network. The at least one price incentive table can be used, for example, to create a charging plan that is optimized with respect to charging that is as inexpensive as possible, possibly also taking into account the electric vehicle as an electrical buffer of the household energy network.

It is a development that the at least one emission incentive table comprises a forecast amount of CO₂ for generating a particular amount of electricity, for example one kWh. This amount of CO₂ emission can change diurnally, for example depending on how much solar energy is fed into the public electricity distribution network by private households. The at least one emission incentive table can be used, for example, to create a charging plan that is optimized with respect to charging with as low CO₂ emissions as possible, possibly also taking into account the electric vehicle as an electrical buffer of the household energy network.

It is a development that a user of the property and/or of the electric vehicle can indicate the target for which the charging plan is intended to be optimized, for example optimized with respect to inexpensive charging or charging with low CO₂ emissions. It is also possible to indicate a mixed target, for example charging with low CO₂ emissions, in which case, however, a cost disadvantage with respect to purely cost-optimized charging should not exceed an amount of X €, etc.

It is a configuration that, when the electric vehicle is connected to the charging point, charging parameters are transmitted from the electric vehicle to the incentive table creation device and to the external IT system and are taken into account there when creating at least one incentive table. For example, the departure time can be used to define the temporal horizon of the incentive tables and/or to define the number of supporting points of the incentive tables.

It is a configuration that the at least one further item of charging-relevant information, which is known to the external IT system but not to the incentive table creation device, comprises information pertinent to the connected electric vehicle, in particular at least one charging parameter.

It is a configuration that the at least one further item of charging-relevant information comprises at least one charging parameter of the electric vehicle that is not known to the incentive table creation device, for example this at least one charging parameter has not been transmitted from the electric vehicle to the incentive table creation device but to the external IT system, or because the charging parameter has been disclosed to the external IT system but not to the electric vehicle and not to the incentive table creation device.

It is a development that certain charging parameters are transmitted from the electric vehicle to the incentive table creation device and are taken into account there for creating the set of incentive tables, in particular the charging power incentive table. Such charging parameters may comprise, for example, information relating to a desired or probable departure time, a desired state of charge at the departure time (“target SoC”) and/or a corresponding amount of energy, a state of charge that should not be undershot (“minimum SoC”) and a maximum and/or minimum charging and/or discharging power. The charging parameters transmitted from the electric vehicle to the incentive table creation device can also be considered or referred to as charging parameters in a first group of charging parameters or “first” charging parameters. Within the scope of this development, the first charging parameters and at least one further item of charging-relevant information in the form of at least one further charging parameter, that is not transmitted to the incentive table creation device, are transmitted to the external IT system. Charging parameters which are not transmitted from the electric vehicle to the incentive table creation device, but are known to the external IT system, for example because they are transmitted to the external IT system, can also be considered or referred to as charging parameters in a second group of charging parameters or “second” charging parameters. A “second” charging parameter is therefore a further item of charging-relevant information.

However, the at least one further item of charging-relevant information may also comprise information relating to the vehicle that is not known to the electric vehicle itself and/or cannot be used by the electric vehicle to create a charging plan. This information may likewise be “second” charging parameters. Such information may be, for example, information derived from historical data relating to a vehicle fleet and/or from field experiments.

It is a configuration that the at least one further item of charging-relevant information that is not known to the incentive table creation device comprises at least one parameter from the group of:
at least one maximum number of wake-up processes of the electric vehicle, in particular its electronics, during the connection period,
maximum frequency of wake-up processes of the electric vehicle, in particular its electronics, during the connection period,
at least one maximum charging activity time of the electric vehicle, and/or maximum energy throughput between the charging point and the electric vehicle during the connection period.

Limiting the maximum number and/or frequency of wake-up processes advantageously limits a load on the vehicle electronics caused by their start-up, for example from a quiescent or standby state. An energy consumption of the vehicle electronics is therefore also advantageously kept within limits. Wake-up processes may occur, for example, when (a) a new set of incentive tables is created and is intended to be transmitted to the electric vehicle in order to be converted there into a new charging plan, and/or (b) the drive battery is charged or discharged, etc. The number and/or frequency of wake-up processes can be limited, for example, such that the number of new charging plans permitted for the electric vehicle during the connection period is limited and/or the number of charging and discharging phases following a respective dead time that is provided in a charging plan is limited.

The “maximum charging activity time” denotes that period of time, in particular until the departure time, in which the drive battery can be charged and/or discharged and is not in the quiescent or standby mode, for example. The “at least one” maximum charging activity time may comprise a duration of the charging activity stated in absolute terms, for example a maximum of 3 h, and/or a percentage (for example a maximum of 20%) of the connection period or the like.

It is a development that the at least one maximum number of wake-up processes of the electric vehicle comprises or is a number of wake-up processes for receiving sets of incentive tables. A new set of incentive tables may have been created, for example, because certain forecasts such as electricity tariffs, weather forecasts, etc. have changed since the creation of the last set of incentive tables. For receiving a set of incentive tables, vehicle electronics in their quiescent or standby state must be started or woken up.

It is a development that the at least one maximum number of wake-up processes of the electric vehicle comprises or is a maximum number of wake-up processes caused by receiving sets of incentive tables while performing a charging plan. This advantageously limits the number of wake-up processes while performing a charging plan itself. It is taken into account that the charging plan, in particular in the case of a long connection period of the vehicle, may have charging dead times in which no charging (that is to say charging and discharging) is intended to be carried out. The vehicle electronics are typically in their quiescent or standby state in these charging dead times. This configuration prevents an excessively frequent change between charging and non-charging phases.

It is a development that the maximum number of wake-up processes until the departure time of the electric vehicle is stated, for example a maximum of five wake-up phases until the departure time. Alternatively or additionally, it is possible to state the maximum number of wake-up processes for each period, for every 8 h, for every 12 h or for every 24 h.

It is a development that the maximum number of wake-up processes is between four and ten, in particular between five and seven, in particular five.

It is a development that the maximum number of wake-up processes and/or the maximum energy throughput represent(s) the maximum value during a predefined time frame, for example the maximum number during a day, half a day or fractions or multiples of a day.

It is a development that the maximum frequency of wake-up processes is between one and two per hour, in particular one wake-up process per hour.

Limiting the energy throughput between the charging point and the electric vehicle during the connection period advantageously protects the drive battery of the electric vehicle. An energy throughput can be understood as meaning, in particular, the electrical energy, power or amount of electricity exchanged between the charging point and the electric vehicle without taking into account the current direction.

It is a configuration that at least one of the charging parameters is dependent on a state of health (also SoH) of the drive battery of the electric vehicle. This helps to further protect the vehicle components loaded during charging, in particular the drive battery itself. For example, the maximum energy throughput can be reduced when an SoH of the drive battery is comparatively low (for example on account of its age, a high number of fast charging processes, etc.).

In addition or as an alternative to the state of health, at least one of the charging parameters may be dependent on at least one other influencing variable, for example an age of vehicle electronics, an external temperature, hardware and/or software updates performed and/or a user behavior of a user of the electric vehicle, etc. In order to provide the further influencing parameters and possibly influencing variables, it is particularly advantageous if the external IT system is an IT system belonging to a manufacturer of the electric vehicle, since the manufacturer has particularly high technical competence for defining and possibly also changing/updating the at least one further charging parameter.

It is a configuration that the modified set of incentive tables created by the external IT system can be rejected by the incentive table creation device and/or the electric vehicle. This results in the advantage that it is possible to prevent the electric vehicle from creating a charging plan that is disadvantageous or undesirable for the operator of the property, for example the homeowner. This configuration can comprise the fact that the modified set of incentive tables created by the external IT system can be automatically rejected by the incentive table creation device and/or the electric vehicle. Alternatively, the modified set of incentive tables can be accepted or rejected by the operator of the property following a query (for example via a user terminal). It is a development that the external IT system submits the modified set of incentive tables created by it to the operator of the property for acceptance or rejection (for example via a user terminal) and transmits it, only after acceptance, to the incentive table creation device and/or the electric vehicle which is then either tied to the acceptance by the operator of the property or can nevertheless reject the modified set of incentive tables.

It is a configuration that the incentive table creation device creates a new set of incentive tables at different times during the connection period of the electric vehicle. This is advantageous in order to be able to take into account changed boundary conditions which were used when creating the previous set of incentive tables. Such changed boundary conditions may comprise, for example, changed electricity tariffs, a changed weather forecast, etc. The method can be run through again with each set of incentive tables created by the incentive table creation device.

It is a configuration that the external IT system can also reject the set of incentive tables sent by the incentive table creation device depending on the result of the analysis. The rejected set of incentive tables is then not transmitted to the electric vehicle. The electric vehicle can then be charged by means of a charging plan based on the previously received set of incentive tables. The set of incentive tables transmitted by the incentive table creation device to the external IT system may be rejected, for example, when it is not allowed by the further charging-relevant information that is known only to the external IT system. For example, there may be a rejection because a maximum number of wake-up processes of the electric vehicle has been reached or an implementation of a new set of incentive tables would result in undesirable waking-up of the electric vehicle. It is a development that the first set of incentive tables transmitted from the incentive table creation device to the external IT system during the connection period cannot be rejected by the external IT system. This advantageously ensures that the electric vehicle is charged.

It is a configuration that the external IT system has at least one proprietary electricity tariff and additionally analyzes and approves, modifies or, if possible, also rejects the set of incentive tables based on the at least one proprietary electricity tariff. In this case, possibly better electricity tariffs may be advantageously provided by the external IT system than the property alone, for example because the external IT system, with its many electric vehicles maintained by it, possibly has a better market position and/or a broader tariff selection than the property alone. The external IT system can then provide the proprietary electricity tariff with the modified set of incentive tables, possibly for a payment. The “proprietary” electricity tariff is therefore an electricity tariff that is made available to the external IT system for charging the associated electric vehicles, but not the property alone. In particular, a “proprietary” electricity tariff may be an electricity tariff specifically negotiated by the external IT system. The external IT system can purchase the proprietary electricity tariff, for example on energy markets, network system service markets for network stabilization, etc.

The object is also achieved by means of a charging infrastructure for charging an electric vehicle, which is configured to carry out the method described above. The charging infrastructure may be designed in a similar manner to the method, and vice versa, and has the same advantages.

It is a configuration that the charging infrastructure comprises:
a property with a household energy network which is connected to a public energy distribution network via a network connection point and comprises at least one charging point which is configured for the bidirectional charging of electric vehicles, and
an incentive table creation device which is configured to provide a set of incentive tables comprising at least one incentive table for the electric vehicle based on at least electricity usage information relating to the property and electricity provision information relating to the energy distribution network and to transmit the set of incentive tables to an external IT system, wherein
the external IT system is configured to analyze the set of incentive tables on the basis of at least one further item of information relevant to the charging of the electric vehicle and, depending on a result of the analysis, to approve the set of incentive tables sent by the incentive table creation device without change or to create a modified set of incentive tables comprising at least one changed incentive table,
wherein the incentive table creation device is also configured
to transmit the set of incentive tables that has been approved without change (if no modified set of incentive tables has been created) or the modified set of incentive tables to the electric vehicle.

It is a development that the charging infrastructure has a household energy management system, HEMS, which is an independent component of the charging infrastructure. It may be implemented, for example, on a data processing device of the property or of the household energy network, for example by means of appropriate programming. However, the household energy management system may also be an entity outside the property which is communicatively coupled, for example, to the property, for example a network server or a cloud computer.

The object is also achieved by means of a system having a charging infrastructure as described above and at least one electric vehicle connected thereto via a respective charging point, wherein the electric vehicle is configured to convert a received set of incentive tables into a charging plan and to be charged according to the charging plan.

The above-described properties, features and advantages of this invention and the manner in which they are achieved become clearer and more distinctly comprehensible in connection with the following schematic description of an exemplary embodiment that is explained in more detail in connection with the drawings.

### BRIEF DESCRIPTION OF THE DRAWINGS

FIG. 1 shows a sketch of a charging infrastructure for charging an electric vehicle; and

FIG. 2 shows a simplified possible sequence for charging an electric vehicle using the charging infrastructure shown in FIG. 1.

### DETAILED DESCRIPTION OF THE DRAWINGS

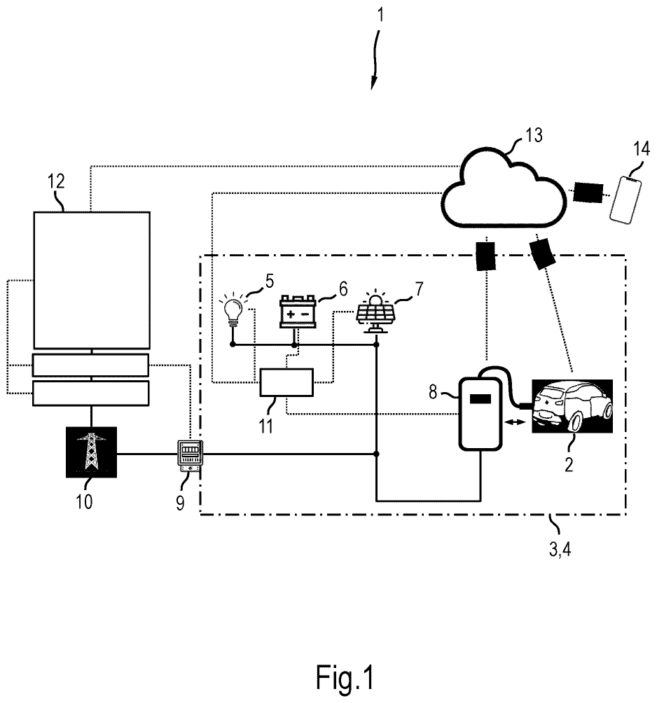

FIG. 1 shows a sketch of a charging infrastructure 1 for charging an electric vehicle 2. The charging infrastructure 1 comprises a property, here by way of example a single-family house 3, with a household energy network 4 for supplying electrical consumers 5 with electricity. A photovoltaic system 6, a steady-state electrical buffer 7 and a charging point in the form of a wallbox 8 are also integrated in the household energy network 4. In one development, the buffer 7 may be integrated in the photovoltaic system 6.

The household energy network 4 is connected here, by way of example, to a public electricity network or energy distribution network 10 via a measurement point or a network connection point in the form of a so-called “smart meter” 9. The electric vehicle 2 can be connected to the wallbox 8 for charging. If the electric vehicle 2 is connected to the wallbox 8, the electric vehicle may be used, within the framework of certain charging parameters, as a buffer for the household energy network 4 and can be accordingly charged and discharged. The wallbox 8 and the electric vehicle 2 may exchange data, for example via ISO 15118-2 and/or ISO 15118-20. In particular, the wallbox 8 may receive, from the electric vehicle 2, charging parameters such as a battery capacity, a stated or estimated departure time, a target SoC at the departure time, a maximum charging power, a minimum SoC to be complied with, etc.

The household energy network 4 also comprises a household energy management system or HEMS 11 which is configured to control a charging and discharging process of the buffer 7 and, when connected, uses the drive battery of the electric vehicle 2 as a temporary buffer. The HEMS 11 is connected, using data technology, if possible, to at least one of the consumers 5, the photovoltaic system 6, the steady-state buffer 7 and the wallbox 8, as indicated by the dashed lines. In this case, the HEMS 11 can receive the charging parameters of the electric vehicle via the wallbox 8 or directly from the electric vehicle 2. If, as assumed by way of example in the present case, the network connection point is a “smart meter” 9, the HEMS 11 can also be connected thereto using data technology. However, other data technology topologies can also be fundamentally implemented: for example, the smart meter 9 may be connected to the wallbox 8 using data technology. Instead of a smart meter 9, a private measuring device belonging to the single-family house 3 may also be used.

The HEMS 11 is also connected to at least one participant in an electricity market 12, for example at least one energy supplier, which energy supplier offers electricity to the household energy network 4 according to a particular-possibly temporally variable electricity tariff for removal from the energy distribution network 10 and also defines feed-in prices for feeding an excess of electrical energy into the energy distribution network 10 from the household energy network 4. This forecast tariff information can be transmitted to the HEMS 11 by the participant in the electricity market 12 or by the smart meter 9. The electricity market 12 may comprise, as participants, for example, energy suppliers, energy aggregators, energy markets, network system service markets, external market participants, etc. The participants in the electricity market 12 may collaborate, for example, with network operators and measurement point operators. In addition to the forecast tariff information, the participant in the electricity market 12 may also transmit forecast (“emission”) information relating to a temporal progression of an amount of CO2 emission for providing a certain amount of electricity from the energy distribution network 10 to the HEMS 11.

The HEMS 11 may generate one or more incentive tables for the electric vehicle 2 on the basis of a forecast of a consumption in the household energy network 4, a forecast of energy production by the photovoltaic system 6 (for example also using weather forecasts), the tariff information transmitted by the participant in the electricity market 12, and the emission information transmitted by the participant in the electricity market 12, which incentive tables are combined in a set of incentive tables. The set of incentive tables created by the HEMS 11 (also referred to as the “HEMS set of incentive tables” below) can also take into account the charging parameters transmitted by the electric vehicle 2.

In the present case, the charging infrastructure 1 additionally has an external IT system 13 or is communicatively coupled to an external IT system 13 which is configured to analyze the HEMS set of incentive tables created by the HEMS 11 on the basis of at least one further item of charging-relevant information that is known to the external IT system 13 but not to the HEMS 11. For this purpose, before carrying out the analysis, the HEMS set of incentive tables is transmitted to the external IT system 13, for example directly from the HEMS 11 or via the wallbox 8. Depending on the result of the analysis, the external IT system 13 can approve the HEMS set of incentive tables without change, can create a modified set of incentive tables or can optionally also reject the HEMS set of incentive tables. The charging-relevant information may comprise, for example, at least one further (“second”) charging parameter from the group comprising: maximum number of wake-up processes of the electric vehicle during the connection period, maximum frequency of wake-up processes of the electric vehicle during the connection period, at least one maximum charging activity time of the electric vehicle and/or maximum (bidirectional) energy throughput between the wallbox 8 and the electric vehicle 2 during the connection period. At least one of these second charging parameters may be dependent on a state of health of a drive battery of the electric vehicle 2, its temperature, an ambient temperature, etc.

The external IT system 13 may also have at least one proprietary electricity tariff, which is not available to the HEMS 11, and may additionally analyze and approve, change or possibly reject the HEMS set of incentive tables on the basis of the at least one proprietary electricity tariff. This proprietary electricity tariff may have been purchased, for example, by the external IT system 13 on the electricity market 12 and may be provided to those household energy networks 4 which are accordingly contractually associated with the external IT system 13.

The external IT system 13 may be, for example, an IT system operated or maintained by a manufacturer of the electric vehicle 2. The external IT system 13 may have a network server and/or may be cloud-based, for example. The external IT system 13 may also be directly connected using data technology, for example wirelessly, to the electric vehicle 2, the wallbox 8 and/or a user terminal 14, for example a mobile user terminal such as a smartphone or tablet PC. As a result, a user of the electric vehicle 2 can be informed of a charging process of the electric vehicle 2, for example, can input specifications, for example with regard to a departure time, can grant approvals, for example for particular charging plans, or can communicate rejections.

If the HEMS set of incentive tables is approved without change by the external IT system 13, this can be communicated to the HEMS 11, and the HEMS 11 then transmits the HEMS set of incentive tables that has been approved without change to the electric vehicle 2.

If a modified set of incentive tables, which differs from the HEMS set of incentive tables, has been created by the external IT system 13, the modified set of incentive tables is transmitted to the HEMS 11 and is transmitted from there to the electric vehicle 2.

If the HEMS charging plan has been rejected, the electric vehicle 2 is still charged, in particular, by means of a charging plan based on the previously received set of incentive tables. In one development, it is possible for the first HEMS set of incentive tables transmitted from the HEMS 11 to the external IT system 13 during the connection period of the electric vehicle 2 not to be able to be rejected by the external IT system 13, but rather, for example, only the second, third etc. HEMS set of incentive tables transmitted to the external IT system 13.

In one development, it is possible for the modified set of incentive tables created by the external IT system 13 to be rejected by the HEMS 11, for example because it contravenes specifications from the homeowner.

Based on the last received set of incentive tables, the electric vehicle 2 creates a charging plan which is also agreed with the wallbox 8, in particular, and is communicated to the wallbox 8. The electric vehicle 2 can then be charged according to the charging plan.

FIG. 2 shows a simplified possible sequence for charging an electric vehicle 2 using the charging infrastructure 1 shown in FIG. 1.

In step S1, the electric vehicle 2 is connected to the wallbox 8, for example via a charging cable.

In a step S2, the electric vehicle 2 then transmits first charging parameters, such as a likely departure time, a target SoC at the departure time, a minimum SoC, etc., to the wallbox 8 and to the external IT system 13.

In a step S3, the charging parameters—possibly with further information such as a charging mode selected by the wallbox 8 etc.—are transmitted on to the HEMS 11. Alternatively, the charging parameters may be directly transmitted by the wallbox 8 to the HEMS 11 in step S2.

In a step S4, the HEMS 11 receives tariff power specifications (envelope) for energy removal and energy feed from one of the participants in the electricity market 12, such as an energy supplier. In step S4, the HEMS 11 also receives further forecasts, such as weather forecasts etc., for example from a weather service 15.

In a step S5, the HEMS 11 uses the information received in step S4 and possibly the first charging parameters to generate a (HEMS) set of incentive tables for the electric vehicle 2 and sends it to the external IT system 13.

In a step S6, the external IT system 13 analyzes the HEMS set of incentive tables, possibly taking into account forecast tariff and/or emission information relating to a proprietary electricity tariff on the electricity market 12, and reacts, for example by approving the set of incentive tables or creating a modified set of incentive tables.

In a step S7, the reaction of the external IT system 13 is transmitted to the HEMS 11. If, for example, the HEMS set of incentive tables is intended to be approved, this can take place directly by transmitting a corresponding approval message from the external IT system 13 to the HEMS 11 or indirectly by virtue of no reaction within a predefined period of time (for example in the sense of a timeout).

In a step S8, the (directly or indirectly) approved set of incentive tables or the modified set of incentive tables is transmitted from the HEMS 11 to the wallbox 8 and from the wallbox 8 to the electric vehicle. Alternatively, the approved or modified set of incentive tables can be transmitted directly from the external IT system 13 to the wallbox 8 or the electric vehicle 2, specifically with or without notifying the HEMS 11.

In a step S9, the electric vehicle 2 uses the received set of incentive tables to create a charging plan and transmits it to the wallbox 8.

In a step S10, the electric vehicle 2 is charged at the wallbox 8 according to the charging plan created in step S9.

In a step S11, the HEMS 11 creates a new HEMS set of incentive tables in a similar manner to step S5, for example in the event of a change in the tariff, emission and/or power specifications and/or the forecasts, such as a weather forecast, etc. Steps S6 to S10 can then be run through again, wherein, in step S6, the new HEMS set of incentive tables can now also be simply rejected by the external IT system 13, for example because a maximum number of wake-up processes of the electric vehicle 2 has been reached and an implementation of a new set of incentive tables would result in undesirable waking-up of the electric vehicle 2.

It goes without saying that the present invention is not restricted to the exemplary embodiment shown.

It is a development that a user is informed of a charging plan to be implemented for charging. It is a development that a user can accept and/or reject a charging plan, in particular a new charging plan. In one development, a user can also confirm an automatically estimated departure time, can himself state a departure time and/or can shift a departure time.

### LIST OF REFERENCE SIGNS

1 Charging infrastructure
2 Electric vehicle
3 Single-family house
4 Household energy network
5 Electrical consumer
6 Photovoltaic system
7 Electrical buffer
8 Wallbox
9 Smart meter
10 Energy distribution network
11 Household energy management system
12 Electricity market
13 External IT system
14 User terminal
15 Weather service
S1-S11 Method steps

1.-14. (canceled)

15. A method for charging an electric vehicle at a charging point of a property, a local household energy network of which is connected to a public energy distribution network, the method comprising:
connecting the electric vehicle to the charging point;
providing, by an incentive table creation device of the property, a set of incentive tables including at least one incentive table for the electric vehicle based on at least electricity usage information relating to the property and electricity provision information relating to the energy distribution network;
transmitting, by the incentive table creation device, the set of incentive tables to an external IT system;
analyzing, by the external IT system, the set of incentive tables based on at least one further item of information relevant to the charging of the electric vehicle;
depending on a result of the analyzing, approving, by the external IT system, the set of incentive tables sent by the incentive table creation device without change or creating a modified set of incentive tables including at least one changed incentive table;
transmitting the set of incentive tables that has been approved without change or has been modified to the electric vehicle;
converting, by the electric vehicle, a received set of incentive tables into a charging plan; and
charging the electric vehicle according to the charging plan.

16. The method according to claim 15, wherein the incentive table creation device is integrated in the charging point or in a household energy management system.

17. The method according to claim 15, wherein the set of incentive tables includes at least one of:
a charging power incentive table comprising a temporal progression of a maximum charging power,
a price incentive table comprising a temporal progression of a price for charging the electric vehicle, and
a emission incentive table comprising a temporal progression of a CO2 emission for charging the electric vehicle.

18. The method according to claim 16, wherein the set of incentive tables includes at least one of:
a charging power incentive table comprising a temporal progression of a maximum charging power,
a price incentive table comprising a temporal progression of a price for charging the electric vehicle, and
a emission incentive table comprising a temporal progression of a CO2 emission for charging the electric vehicle.

19. The method according to claim 17, wherein, when the electric vehicle is connected to the charging point, vehicle-specific charging parameters are transmitted from the electric vehicle to the incentive table creation device and to the external IT system and are taken into account there when creating at least one incentive table.

20. The method according to claim 18, wherein, when the electric vehicle is connected to the charging point, vehicle-specific charging parameters are transmitted from the electric vehicle to the incentive table creation device and to the external IT system and are taken into account there when creating at least one incentive table.

21. The method according to claim 15, wherein the at least one further item of charging-relevant information, which is known to the external IT system but not to the incentive table creation device, comprises information pertinent to the connected electric vehicle including at least one charging parameter.

22. The method according to claim 16, wherein the at least one further item of charging-relevant information, which is known to the external IT system but not to the incentive table creation device, comprises information pertinent to the connected electric vehicle including at least one charging parameter.

23. The method according to claim 21, wherein the at least one further item of charging-relevant information comprises at least one charging parameter of the electric vehicle that is not known to the incentive table creation device.

24. The method according to claim 22, wherein the at least one further item of charging-relevant information comprises at least one charging parameter of the electric vehicle that is not known to the incentive table creation device.

25. The method according to claim 23, wherein the at least one charging parameter that is not known to the incentive table creation device comprises at least one parameter from the group of:
at least one maximum number of wake-up processes of the electric vehicle during a connection period,
maximum frequency of wake-up processes of the electric vehicle during the connection period,
at least one maximum charging activity time of the electric vehicle, and maximum energy throughput between the charging point and the electric vehicle during the connection period.

26. The method according to claim 24, wherein the at least one charging parameter that is not known to the incentive table creation device comprises at least one parameter from the group of:
at least one maximum number of wake-up processes of the electric vehicle during a connection period,
maximum frequency of wake-up processes of the electric vehicle during the connection period,
at least one maximum charging activity time of the electric vehicle, and maximum energy throughput between the charging point and the electric vehicle during the connection period.

27. The method according to claim 19, wherein at least one of the charging parameters is dependent on a state of health of a drive battery of the electric vehicle, an age of vehicle electronics, an external temperature and/or a user behavior of a user of the electric vehicle.

28. The method according to claim 20, wherein at least one of the charging parameters is dependent on a state of health of a drive battery of the electric vehicle, an age of vehicle electronics, an external temperature and/or a user behavior of a user of the electric vehicle.

29. The method according to claim 15, wherein the modified set of incentive tables created by the external IT system are rejectable by the incentive table creation device and/or the electric vehicle.

30. The method according to claim 15, wherein the incentive table creation device creates a new set of incentive tables at different times during a connection period of the electric vehicle.

31. The method according to claim 15, wherein the external IT system can reject the set of incentive tables sent by the incentive table creation device depending on the result of the analyzing, wherein the first set of incentive tables transmitted from the incentive table creation device to the external IT system during a connection period of the electric vehicle cannot be rejected by the external IT system.

32. The method according to claim 15, wherein the external IT system has at least one proprietary electricity tariff and additionally analyzes the set of incentive tables based on the at least one proprietary electricity tariff.

33. The method according to claim 15, wherein the external IT system is maintained by a manufacturer of the electric vehicle.

34. A charging infrastructure configured to charge an electric vehicle, the charging infrastructure comprising:
a property with a household energy network which is connected to a public energy distribution network via a network connection point and includes at least one charging point which is configured for bidirectional charging of electric vehicles and can receive charging parameters from the electric vehicle connected thereto; and
an incentive table creation device configured to provide a set of incentive tables including at least one incentive table for the electric vehicle based on at least electricity usage information relating to the property and electricity provision information relating to the energy distribution network and to transmit the set of incentive tables to an external IT system;
wherein the external IT system is configured to analyze the set of incentive tables based on at least one further item of information relevant to the charging of the electric vehicle and, depending on a result of an analysis, to approve the set of incentive tables sent by the incentive table creation device without change or to create a modified set of incentive tables including at least one changed incentive table; and
wherein the incentive table creation device is also configured to transmit the set of incentive tables that has been approved without change or the modified set of incentive tables to the electric vehicle.
